(19) United States
(12) Patent Application Publication
(10) Pub. No.: US 2009/0262181 A1
(43) Pub. Date: Oct. 22, 2009

(54) REAL-TIME VIDEO SIGNAL INTERWEAVING FOR AUTOSTEREOSCOPIC DISPLAY

(75) Inventors: Gal ROTEM, Moshav Beit-Uziel (IL); Ofir Shefer, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignees: Gal Rotem, Moshav Beit-Uziel (IL); Ofir Shefer, Tel Aviv (IL); David Ohayon, Kfar Saba (IL)

(21) Appl. No.: 12/104,546

(22) Filed: Apr. 17, 2008

(51) Int. Cl. H04N 13/02

(52) U.S. Cl. 348/46; 348/E13.074

(57) ABSTRACT

A method, apparatus and system for simultaneously capturing a plurality of video signals that carry images of a changing real three-dimensional scene, taken from respective different directions, and for combining them, in real time, into an interwoven video signal, ready to be fed to an active-matrix-based autostereoscopic display device.

### FIELD OF THE INVENTION

The field of the invention is autostereoscopic display systems and, in particular, systems for real-time autostereoscopic imaging of changing real scenes.

### BACKGROUND

By the term autostereoscopy we mean, generally, the display of a virtual three-dimensional image of an object or a scene (the two terms to be used interchangeably), based on a plurality of two-dimensional images (to be referred to as “projection images”) that represent projections of the object to, or views of the object from, corresponding different directions, spread in a horizontal plane. The display allows viewing the virtual image from a plurality of directions, corresponding to and usually similar to, those of the projection images. The projection directions, and therefore also the viewing directions, are usually chosen so that at a normal viewing distance they correspond to the inter-ocular distance. They thus enable, upon binocular viewing from any of the available viewing directions, a stereoscopic visual effect.

The object or scene may originally be a real one, to be remotely visualized by means of an autostereoscopic reproduction system, or it may in itself be a virtual object or scene, created computationally and visualized through an autostereoscopic display. The present invention addresses the former situation—that of real objects or scenes, which need to be sensed in order to create the projection images. Objects or scenes addressed by the present invention, moreover, are generally such that move or otherwise change with time, thus necessitating producing all the images repeatedly, preferably at a regular rate, so as to visually convey the motion or the changes.

Depending on the application and the type of scenes to be thus visualized, the sensing of the scene may be in any of a variety of modalities. The most common modality is passive optical sensing, which may further be characterized by a relevant band of wavelengths and which will be discussed herebelow. Other possible modalities include, but are not limited to, ultrasonic echoing, radio- or optical echoing and x-ray projections.

Optical sensing typically involves video cameras. A plurality of cameras may be arranged regularly spaced along an arc around the scene, pointing at it from various directions. Alternatively, a single camera may move along an arc (or, if the distance to the scene is great, along a straight line) and sequentially produce images from various directions. An interesting range of applications for near scene viewing is those in which the scene is in a hostile environment, e.g. high-temperature, radiation or chemically aggressive environment. An interesting application that involves remote scenes is aerial reconnaissance; here a single moving camera is the proper means for sensing and the resultant virtual object would be a moving 3-d image of the terrain.

A crucial component of an autostereoscopic system is the autostereoscopic display device (or subsystem). U.S. Pat. No. 5,223,925 (to Hattori) and U.S. Pat. No. 5,430,474 (to Hines) disclose, each, an autostereoscopic subsystem, which receives video signals from a plurality of cameras and applies them to corresponding video display devices. The display devices are arranged regularly spaced at some distance behind a screen and the images appearing thereon are optically projected toward the screen. The latter acts as a field lens, focusing the projection lenses onto a viewing plane in front of the screen. An observer may then view the various video displays from directions that correspond to the optical projections. The display subsystems thus disclosed have the disadvantages of being bulky and of requiring precise alignment of the display devices relative to each other and to the screen. A further disadvantage is that if the scene need to be recorded for future display, a plurality of video signals must be stored, which may require a commensurate large capacity.

Recently a class of integrated autostereoscopic devices has become known and is commercially available. Such a device typically consists of a flat display screen (also known as active-matrix display screen) with a matrix of light emitting or light modulating elements, usually in three primary colors, such as serving for high-definition 2-D display, and means for directing the light from certain groups of elements into respective horizontally-spread viewing directions. Elements belonging to the various groups are interspersed in patterns that usually form parallel lines that run generally vertically. Each such group of elements receives display image values corresponding to a respective projection image. The display image values are assigned to the elements of the various groups according to patterns that relate to their interspersion patterns. All the image values for all the elements on the screen are fed to the display device as a single digital video signal, known as an interwoven video signal, which is in a format to feed image values to the elements in a line-by-line sequence and wherein the values for the various groups are interwoven.

Two types of light-directing means for active-matrix autostereoscopic display devices are generally known: In one type, known as “parallax barrier”, there is a mask screen, parallel to the active matrix screen and at some distance therefrom that consists of narrow transparent strips in an otherwise opaque background; the strips are parallel to the elements interspersion pattern and aligned therewith so that only a respective group of elements is visible from any given direction. In the second type of light-directing means there is a lenticular screen, parallel to the active matrix screen, which has an array of narrow cylindrical lenses, whose focal lines are in the plane of the active matrix screen and aligned with the elements interspersion pattern so that the various groups of elements are projected by the lenses into their respective directions. The present invention is applicable to autostereoscopic active matrix displays with any type of light-directing means.

Active matrix based autostereoscopic display devices are relatively compact and easily lend themselves to a wide variety of applications. Currently they are used primarily for advertising and the displayed contents are generally virtual scenes that were created in computers or images of real objects that were processed off-line in computers. In either case, the scene or object may be moving or changing, but over a limited, pre-determined, time period. The process of preparing such images, from either source, for display on such autostereoscopic devices is relatively lengthy and therefore is not carried out in real-time (relative to changes in the scene). For this reason there are currently no active-matrix-based autostereoscopic imaging systems available that can capture, in real time and simultaneously, a plurality of sequences of projection-images of a changing real scene, the sequences being unlimited in duration. As noted above, projection-type autostereoscopic systems, such as disclosed in the aforementioned patents, though amenable to real-time imaging, are cumbersome and also require large storage capacity for any intermediate storage of image sequences.

It would therefore be useful and desirable to have a method and a system that can, in real time and simultaneously, capture a plurality of sequences, unlimited in duration, of projection-images of a changing real scene and combine them into an interwoven video signal, ready to be fed to an active-matrix-based autostereoseopic imaging device.

### SUMMARY OF THE INVENTION

In one aspect the invention is of a method for real-time generation of a display video signal, adapted to be fed to an autostereoscopic display device for displaying an autostereoscopic video image of a changing three-dimensional scene, the display device including a matrix of active light-emitting or light-modulating elements, arranged in rows, and the display video signal structured as a sequence of frames, each frame structured as a sequence of lines that correspond to consecutive rows of said elements, the method comprising:
(a) Simultaneously obtaining a plurality of projection video signals, each signal structured as a sequence of frames representing two-dimensional projection images of the scene in a respective different direction and each frame including a plurality of pixels, each pixel carried as one or more digital values;
(b) copying pixel values from the projection video signals, or from any processed version thereof, into a digital representation of one or more of the rows so that values from different projection video signals become mutually interwoven.
(c) reading out said copied values from said digital representation in a line-by-line sequence and formatting them into the display video signal.

Thus the method of the invention calls for simultaneously, and in real time, capturing a plurality of sequences, unlimited in duration, of projection-images of a changing real three-dimensional scene and for combining them into an interwoven video signal, ready to be fed to an active-matrix-based autostereoscopic imaging device. The projection-images may be obtained from any source, or set of sources, and may be produced by sensing the scene in any of a variety of modalities, including, but not limited to, passive optical sensing, radio- or optical echoing, ultrasonic echoing and x-ray projection. Each sequence consists of consecutive video frames, that represent corresponding views, or projection images, of the scene, repeated indefinitely, preferably at regular time intervals, all sensed at a respective one of a plurality of directions from a reference point in the scene. Preferably video frames in the several sequences are mutually synchronized, so that at any instant there is obtained one frame from each of the sequences, collectively representing a corresponding instant in the changing scene. Preferably images from the several sequences are, at any given moment, also mutually aligned geometrically, so that at least one pixel in each of the several simultaneous video frames, corresponding to a particular point in the scene, is at an identical location within its frame. It is noted that the method of the invention does not rely on storing, for any of the signals, a plurality of images of video frames at any stage and thus may be carried out in real time with a delay of at most one video frame duration.

In another aspect the invention is of apparatus for real-time conversion of a plurality of projection video signals, representative of a changeable three-dimensional scene as projected in respective different directions, into a display video signal, adapted to be fed to an autostereoscopic display device for displaying an autostereoscopic image of the scene, each of the projection video signals being structured as a sequence of frames representing corresponding sequential two-dimensional projection images of the scene, the display device including a matrix of active light-emitting or light-modulating elements, arranged in rows, and the display video signal structured as a sequence of frames, each frame structured as a sequence of lines that correspond to consecutive rows of said elements, the apparatus comprising:
a plurality of Conditioning Processors, each receptive to a respective projection video signal and operative to output digital values of sequential pixels representative of corresponding projection images;
a Combiner, including a buffer storage that is adapted to store image values for one or more of said rows, the Combiner being operative to copy values obtained from said Conditioning Processors into said buffer storage so that values from different Conditioning Processors become mutually interwoven; and
a Video Formatter, operative to read out said copied values from said buffer storage in a line-by-line sequence and to format them into the display video signal.

In certain configurations of the apparatus, the Combiner further includes a plurality of mapping filters, each receptive to digital values output by a respective Conditioning Processor and operative to copy them selectively according to a given mapping function.

In some other configurations of the apparatus, the Combiner further includes a Mapper, operative to address each of said values to a respective location in said buffer storage according to a given mapping function.

In yet another aspect the invention is of a system for continuous real-time autostereoscopic display of a changing three-dimensional scene, comprising:
means for sensing the scene from a plurality of directions and for outputting a plurality of corresponding projection video signals;
an active-matrix autostereoscopic display device; and
apparatus receptive to said projection video signals and operative to convert them into a display video signal, adapted to be fed to said display device for displaying an autostereoscopic image of the scene.

For each set of simultaneous video frames, representing the several projection images, as viewed at a certain instant of time from their respective directions, there is produced, according to the invention, a corresponding single interwoven video frame, wherein pixel values from the several sequences are mapped into assigned active-matrix elements in the display screen. The mapping and assignment are such that pixels from any one sequence are viewable on the display screen from only a corresponding direction. The assignment is directly related to the structure of the display screen, namely the geometric relation between the active-matrix elements and the light directing means (e.g. the cylindrical lenses) and between elements of the various colors (e.g. red, green and blue), if the display is in color. This structure may vary among manufacturers and/or models of active-matrix autostereoscopic display devices. The apparatus and the system, according to the invention, is operative to, and the method of the invention can, carry out the proper mapping for any such structure.

It is noted that one characteristic of any autostereoscopic active-matrix screen structure is the highest number of directions from which the scene may be distinctly viewed. The system according to the invention is adaptable to any such maximal number of directions. It is further noted that the number of projection image sequences, corresponding to directions of projection (or views) of the sensed scene, that may be fed to the system may be smaller than, equal to or greater than the maximal number of directions characterizing the display device; the system according to the invention is adaptable to any such number of sequences, mapping their pixels into corresponding display elements according to any scheme of combining or distributing.

It is also noted that, while an active-matrix screen typically includes light-emitting or -modulating elements in three primary colors, other number of display colors, including single color (typically white), are possible and the system of the invention is adaptable accordingly. Moreover, the number of color components represented by the input projection-image video signals may be different than that of the display device, in which case the system of the invention is adaptable to map such components into corresponding display elements according to any scheme of combining or distributing. The term “color components” with respect to projection images includes also components differentiated along some parameter other than visible wavelength, which may be related to the sensing modality at which they were obtained.

The qualifier “real-time” in the present context refers to the ability of the system to produce any number of consecutive interwoven video frames at the same average rate at which sets of projection-image video frames are obtained—thus obviating the need to store more than one set of frames at any time. This also means that the interwoven video signal (which is ready to be fed to the display device) is obtained at a delay from the corresponding projection video signals that does not exceed one frame time. It is noted that in practice the delay is considerably shorter than one frame time.

In some configurations of the system according to the invention the interwoven video signal is fed directly to one or more autostereoscopic display devices. Their advantage over prior art lies in the ability to display the image of the object on active-matrix devices immediately. In other configurations of the system according to the invention the interwoven video signal is fed to a storage system, whence it can be retrieved at a later time and fed to autostereoscopic display devices. Their advantage over prior art lies in the ability to display the stored video signal directly upon retrieval obviating the process of combining the signals of projection images Another advantage of the latter configurations lies in the ability to store the images in the interwoven video format, which is more compact and thus more efficient in storage space than the format of the original projection images. Other configurations of the system according to the invention provide outputs both directly to display devices and to storage devices.

### BRIEF DESCRIPTION OF THE DRAWINGS

FIG. 1 is a schematic block diagram of a preferred embodiment of the invention in a typical configuration.

FIGS. 2A-2B are schematic drawings illustrating the screen structure of an autostereoscopic active-matrix display.

FIG. 2C is a schematic drawing, showing the screen structure of FIG. 2B and illustrating the mapping of pixels into screen elements.

FIG. 3 is a schematic block diagram of another preferred embodiment of the invention in a typical configuration.

### DESCRIPTION OF PREFERRED EMBODIMENTS

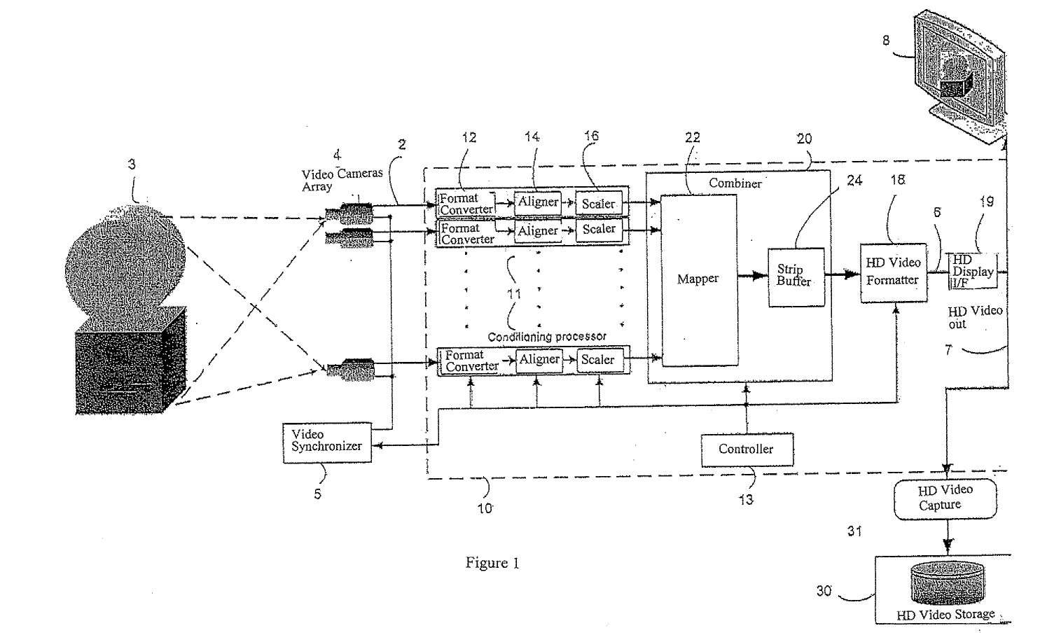

FIG. 1 depicts, in a schematic block diagram, a preferred embodiment of the invention in a typical configuration. Real-time Multiview Video to Autostereoscopic Display Converter (RMVADC) 10 accepts a plurality of video signals 2 and converts them, in real time, to a high-definition (HD) video signal 6 that is applicable to an autostereoscopic display device 8. The plurality of video signals 2, which may be in any suitable format, represent views, or projection images, of an object or a scene 3 (the two terms to be used interchangeably) from respective directions and are accordingly referred to herein as projection video signals. They usually arrive simultaneously from one or more video sources. In the configuration depicted in FIG. 1 the video sources are respective video cameras 4, disposed at certain distances from each other and so as to image the object 3 from respective directions. The video sources are, however, not part of the invention and may, in general, be of any type and in any number. They may, for example, include any type of respective image sensing devices for sensing the shape and structure of the scene from respective directions. The modality of the sensing may be any, including but not limited to passive optical sensing, ultrasonic echoing, radio- or optical echoing and x-ray projections. In the case of passive optical sensing in the visible wavelength range (which is the common and usual modality for natural object and scenes), the images are usually obtained in three primary color components and these are then mapped, pixel by pixel to corresponding color-emitting or -modulating elements in the display device. When the passive optical sensing includes other wavelength range, such as infra-red, the obtained images are usually transformed to three primary-color components, which are displayed in the aforementioned manner; the transformation may be carried out prior to the signals being fed to the system herein described, or it may optionally be performed within the system.

In another possible configuration, the video source may be a single sensor (in any modality) moving in a trajectory with respect to the scene and producing one or more video signal representing sequential images of the scene; such may be the case, for example, in aerial terrain sensing. In yet another configuration, the video source may be a computer system that processes signals from one or more real-time sources and produces video signals of corresponding projection images; such may be the case, for example, in some medical imaging systems.

The autostereoscopic display device 8, which also is not part of the invention, is generally an active-matrix display device with light-directing means, as described hereabove. The HD video signal 6, produced by the RMVADC 10 of the present invention, can be adapted to drive any type of such a device, obtained from any vendor. However, in order to make the following description more concrete and comprehensible, but without detracting from the generality of the invention, the display device will be assumed to have a certain matrix structure and a lenticular type of light-directing means, the lenses having a certain relation to the matrix structure.

Optionally or in certain configurations of the invention, RMVADC 10 can also output an HD video signal in a format adapted to be stored in an HD video storage device 9, which also is not part of the invention and may be of any suitable type. When read out of such storage, the HD video signal may be applied to an autostereoscopic display device, such as discussed above.

The RMVADC 10 will now be described with reference, again, to FIG. 1. It is assumed that all the incoming projection video signals 2 are mutually synchronized, matched and aligned. Synchronization herein means that the frame rates of all the video signals are equal and that corresponding frames in the various signals begin and end essentially simultaneously; such synchronization may be effected for example by means of a Video Synchronizer 5, which may communicate with the RMVDDAC but is not part of it. Matching herein means that corresponding frames in all the video signals represent an identical number of pixels and an identical image format. Alignment herein means that the images represented by corresponding frames in all the signals relate to the scene at essentially the same scale and that at any instant there is at least one pixel, corresponding to a reference point in the scene, that occurs at an essentially identical position within the current frame among all the signals.

Each of the incoming projection video signals 2 is first processed by itself, in parallel with the others, in a respective Conditioning Processor 11 as follows. The signal is applied to a Format converter 12, which serves to convert the signal from whatever format in which it is received into a specific digital format that is internal to the system. As mentioned, the format of the incoming signal may be any, including analog formats (in which case the converter includes an analog-to-digital converter) and digital formats.

The resulting signal (or video image data, as it may also be called), in the internal format, is applied to an Aligner 14, which serves to compensate for any deviations of pixel positions from their nominal positions with respect to the frame, or with respect to the assumed position of pixels corresponding to the reference points. Such deviations may occur in the output of a video camera, or any other video source, owing to drifts or random variation in some physical parameters therein.

The output of the Aligner 14 is applied to a Scaler 16, which serves to scale the digital image resolution, represented by the signal, to that required by the display device. Such scaling generally involves changing the total number of pixels in a frame. Depending on the resolution of the incoming signal, the scaling can be a reduction, which may involve some blurring or low-pass filtering, or an augmentation, which may involve some interpolation. The resolution required by the display device is determined as follows: If the total number of display elements, for each of the three primary colors (if it is a color display), is N and if the number of possible viewing directions is n, then the number of displayable pixels over the entire screen viewable in any one direction is N/n. In the case of a standard High-Definition (HD) video display, for example (which is the case illustrated in the configuration of FIG. 1), there are, for each primary color, 1080 rows of 1920 elements each, for a total of 2,073,600 elements. In its autostereoscopic version this particular device has nine possible viewing directions and thus the total number of displayable pixels (each pixel having a value for each of the three primary colors) is 2,073,600/9=230,400. The latter is the number of pixels that Scaler 16 will output per frame.

It is noted that the parameters N and n in the above are characteristic to any particular autostereoscopic display device and that the apparatus and the method according to the invention can be adapted to any values of these parameters. It is also noted that the Scaler may be programmed to scale the resolution so that it exceed that of the display device, in which case not all pixels in the signal will be displayed (i.e. the image will be clipped), or so that it underfill the display screen. If the aspect ratio of the projection images is different from that of the display device (i.e. 16:9 in the example of standard HD), there will necessarily be clipping or underfilling along one of the two image coordinates.

It is furthermore noted that the number of projection video signals available to the system may be different from n—the maximum number of viewing directions of the display device. If the former exceeds the latter, only n of the available video signals will be input to the system. If the number of available projection video signals, m, is less than n, the system will preferably channel them, through m active Conditioning Processors 11, to the respective m middle ones of the viewing directions. Also to be noted is that the quantity of Conditioning Processors 11 in a system is a parameter, preferably determined to equal the lesser of (1) the maximum desirable number of viewing directions, (2) the maximum expected number of input projection video signals and (3) the maximum number of viewing directions for any display device contemplated to be driven by the system.

The video image data output from Scaler 16 of each Conditioning Processor 11 are applied to Combiner 20, where they are combined to form a single digital video signal, in which pixels and lines are arranged in the sequence expected by the display device 8. In the exemplary configuration of FIG. 1 this signal is in the HD (High Definition) format. During such a combining process each color value of each pixel of each projection image is uniquely mapped into an appropriate position within a frame of the HD signal. Each value in any frame of the HD signal is eventually applied uniquely to a respective light-emitting, or -modulating element in the active matrix of the display device. The unique mapping function is dictated by the two-dimensional structure of the elements and by its geometric relation to the structure of the light-directing means of the display device. The function will now be explained, by way of a non-limiting example, with respect to a particular commercially available display device; the invention is however applicable, with obvious modifications, to any other type or make of an active-matrix display device. The exemplary device uses a large number of cylindrical lenses, disposed in parallel., as the light directing means. It provides nine viewing directions

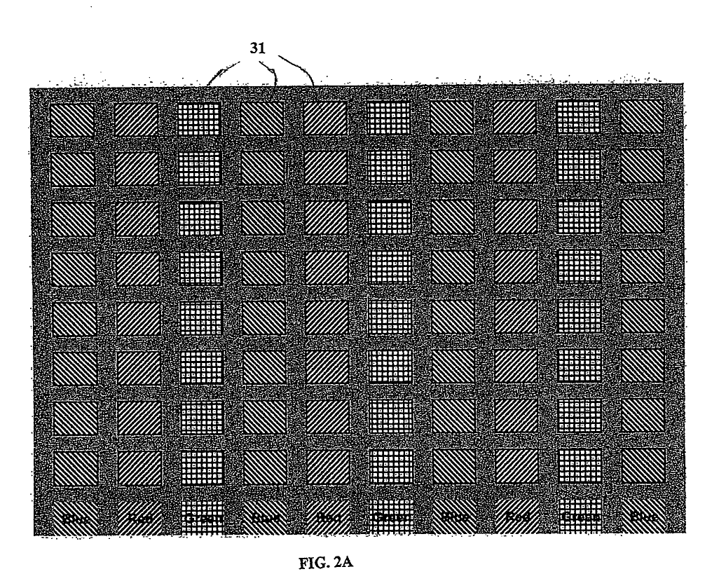

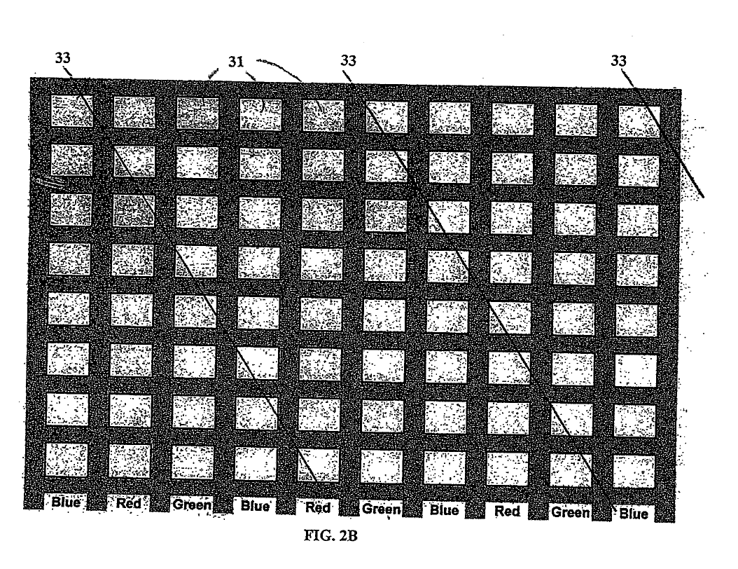

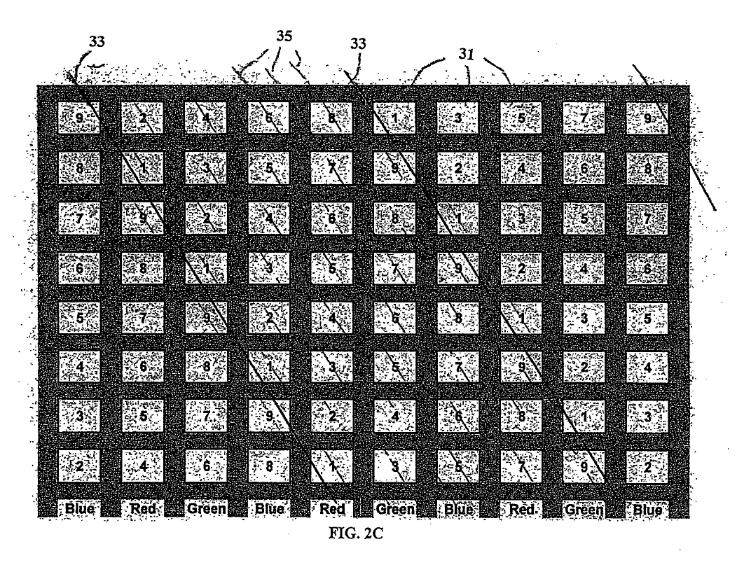

An enlarged face view of a small typical portion of the active matrix of Display Device 8 is shown schematically in FIG. 2A. The small rectangles 31 denote individual elements and the patterns therein represent in this drawing the colors of the emitted, or transmitted, light, as denoted along the bottom row. The three primary colors—red, green and blue—are seen to be arranged in alternating columns. The dark gray areas between the elements represent non-emitting (or non-transmitting) spaces.

FIG. 2B shows schematically the same portion of the matrix but without the color-representing patterns—for clarity. Juxtaposed on the matrix of elements 31, in this normal view, are diagonal lines that represent boundaries (that is—troughs) between adjacent cylindrical lenses attached to the outer surface of the screen. Thus all the elements between a pair of adjacent diagonal lines are viewable through the corresponding lens. It will be recalled that the focal lines of the lenses usually lie in the plane of the faces of the elements. It is noted that the shown rectangles represent the corresponding elements only schematically and that therefore their exact shape and size may be different from that shown; what is important is the geometric relation between the centers of the elements and the lenses.

FIG. 2C is identical to FIG. 2B, except for some additions. We first note the numbers inside the rectangles 31 that represent the matrix elements. These numbers, running from 1 to 9, are associated, on the one hand, with respective projection images and, on the other hand, with respective viewing directions onto the display. The latter association is demonstrated by the diagonal dashed lines 35, which run parallel to lens boundary lines 33. It is readily seen that each dashed line 35 runs primarily through rectangles having identical numbers with a respective single value. Thus, for example, the dashed line closest to the leftmost boundary line 33 runs through rectangles marked by the number 1, the next dashed lines runs through rectangles marked by 2, etc. The significance of this observation is that all elements with a particular number are solely viewable in a corresponding direction. In particular, the elements corresponding to the number 5, which are seen to lie halfway between a pair of boundary lines (and thus under the centerline of the lens) are solely viewable in a direction normal to the screen and thus the corresponding dashed line also represents essentially the focal line of the lens.

It is now further observed that along any one dashed line 35 the color of the elements alternates cyclically—e.g. (in a downward-to-the-right direction) R-G-B-R-G-B, etc. Each such cycle spans six rows of elements. The mapping function considers each such cycle to represent one pixel of the currently displayed image and assigns the corresponding elements a triad of respective values from the appropriate pixel in the corresponding projection image. Thus, for example, a particular pixel in projection image 1 may be mapped into the HD signal so as to affect certain matrix elements as follows (in terms of rows and columns in FIG. 2C): The red value is mapped to affect the second (from left) element of row 2 (from top), the green value is mapped to affect the third element of row 4 and the blue value—the fourth element of row 6. The matching pixel in projection image 2 will be similarly mapped so that the R, G and B values affect, respectively, the second element in row 1, the third element in row 3 and the fourth element in row 5. Similarly the matching pixel in projection image 8, for example, will thus be mapped into the fifth element of row 1, sixth element of row 3 and seventh element of row 5. The next pixel of projection image 1 may be mapped into element 8 of row 5 (red), element 9 of row 7 (green) and element 10 of row 9 (blue), all of which are seen to be lying under the next lens area; the matching pixels of the other projection images will undergo similar mapping within the second lens area.

All in all, pixels from the various projection images are mapped, mutually interlaced, into corresponding elements in the matrix, the three color values of any pixel being mapped into adjacent elements. Horizontally and vertically adjacent pixels of any one projection image are mapped into corresponding elements that are mutually spaced by several rows and several columns; these elements are, moreover, horizontally and vertically displaced. For example, for projection image 2, the red value of a first pixel is applied to element 2 of row 1, but that of the next pixel to the right is applied to element 8 of row 4 (i.e. three rows further down); also, the next pixel down is applied to element 5 (i.e. three columns further to the right) of row 7. Such displacement may cause some smearing or artifacts in the apparent image that extend about the size of a pixel; they may be corrected as explained further below.

It is noted that the mapping function is not part of the invention and is dictated by the structure of the display device. The invention contemplates, however, carrying out such mapping, according to any given function as befitting any given display device, efficiently and with high quality, as described below.

Returning now to FIG. 1, Combiner 20 is seen to include a Mapper 22 and a Strip Buffer 24. The latter is a fast register that holds image data destined for several rows of display matrix elements. The number of such rows is at least that into which all pixels in a set of matching lines, one from each projection image, are mapped, as described hereabove. Mapper 22 periodically receives a pixel (i.e. a triad of color values) from each Conditioning Processor 11 (all the pixels assumed matched and aligned) and addresses it to the appropriate location in Strip Buffer 24, according to the mapping function described hereabove. A running index identifies the position, with respect to the overall matrix, of the destination elements to which the current contents of the buffer are destined. As each row in the Strip Buffer is filled it is transferred out to HD Video Formatter 18, to become a line in the interleaved video signal 6.

In order to avoid the smearing- and artifact effects, pointed out hereabove, the effective positions of some pixels are preferably corrected so as to more closely conform to the locations (i.e. display elements) into which they are to be mapped. This correction is preferably performed, on-the-fly, in Aligners 14 or Scalers 16 and preferably involves interpolating between values of adjacent pixels in the respective projection image. The parameters of such interpolation are derived from the mapping function and may be obtained continually from Mapper 22 or may be stored in the Aligners and read out as needed according to the running index value continually obtained from Mapper 22.

HD Video Formatter 18 is receptive to data output by Combiner 20 (that is—by Strip Buffer 24 therein) and preferably includes two identical buffer registers, each holding data for one video line, i.e. data to affect elements of one row in the display matrix at any instant. The two buffer registers alternate in function: While one accumulates data arriving from the Combiner, the other has its stored data read out, to form a corresponding line-by-line output digital video signal 6. In the configuration of FIG. 1, this signal is formatted according to the HD standard, but may of course assume also any other format. Video Formatter 18 periodically receives from Combiner 20 pixel data for a row of elements and stores them in one of the buffers. Meanwhile data in the other buffer is read out serially (byte-by-byte or possibly pixel-by pixel—depending on the exact format of the signal) and formed into a line in the HD video signal 6. At the end of the line period the roles of the buffers are switched and the process repeats. It is noted that other means and techniques are known in the art for forming the output signal from data provided by the Combiner—all coming within the scope of the present invention.

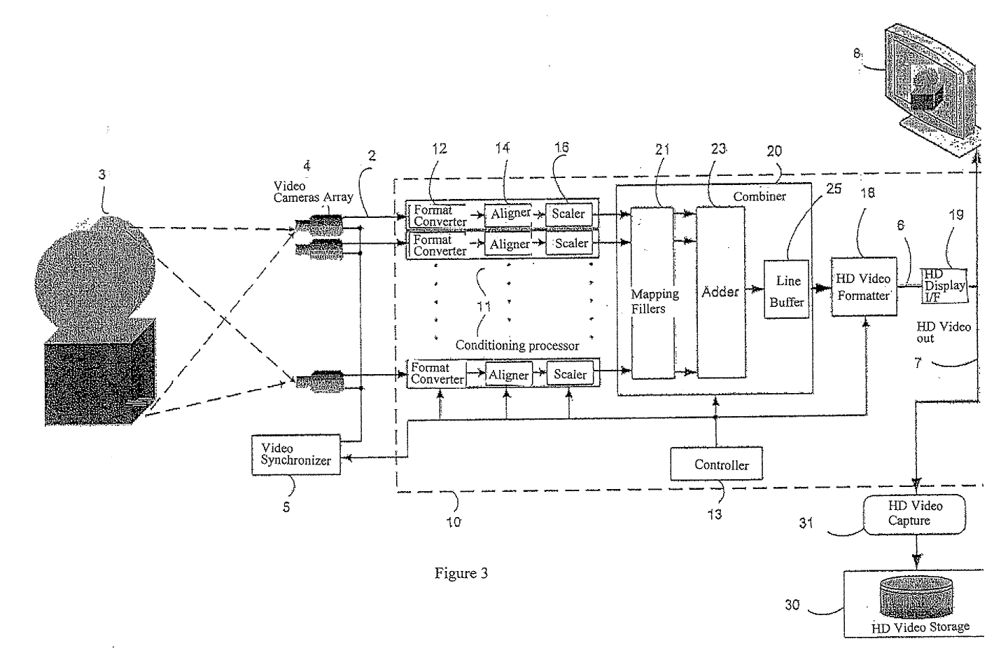

FIG. 3 depicts, in a schematic block diagram, another preferred embodiment of the invention. It is similar to that of FIG. 1, except in the structure of Combiner 20. The latter is seen in FIG. 3 to include a set of n Mapping Filters 21, an Adder 23 and a line buffer 25. In block 21 there is a Mapping Filter corresponding to each Conditioning Processor 11. In this embodiment, Scaler 16 of each Conditioning Processor outputs image data at the full resolution expected by the display device—ideally N pixels in each frame. To the extent that the Projection Video Signal 2, input to the chain, has a different resolution, Scaler 16 will generally change the resolution, increasing or decreasing the number of pixels per frame, so as to best match the display format. Each Mapping Filter of the set 21 is designed to filter, i.e. selectively pass, the values (e.g. the R, G, B values) received from the respective Conditioning Processor for each pixel, passing only those values that must be present, according to the mapping function, in the interwoven image at that pixel's location. The n filters pass values in a mutually exclusive manner, that is: From each set of n pixels output simultaneously by the n Conditioning Processors, only one value for each primary color is passed on. Thus, in the case of three primary colors, only three values at a time are passed on and the other 3x(n−1) values are discarded. It is noted that the three passing values at any instant are generally obtained from three different Conditioning Processors.

In the case of the exemplary mapping function illustrated in FIG. 2C, the gating function of each mapping filter is indicated by the locations of corresponding numerals in the diagram. Thus, for example, the first mapping filter will pass red values only from pixels occurring at locations (with respect to the frame) that correspond to elements designated by red numeral 1 (e.g. cell 2 in row 2 and cell 5 in row 8); the same filter will pass green values only from pixels occurring at locations that correspond to elements with green numeral 1, etc.

The outputs of all Mapping Filters 21 are combined by Adder 23 to form a single stream of values, representing pixel values obtained from all the projection video signals—interwoven according to the mapping function. This stream is collected in Line Buffer 25, which is preferably structured as an alternating double buffer, and is read out therefrom as required by Video Formatter 18.

As noted above, Scalers 16 in effect scale the images carried by the projection video signals so that their resolution becomes that required in the display device. If the original resolution is higher than, equal to, or somewhat lower (say down to one half) than the required one, each image preferably also undergoes spatial low-pass filtering (i.e. blurring)—so as to be commensurate with a resolution (in terms of overall pixel count) n times lower than the required N (which, in effect, is the image resolution after being gated by the Mapping Filter). This is done in order to eliminate possible biasing or moiré effects due to high spatial frequency components.

The combined effect of the Combiner (in either of the embodiments) and the Video Formatter is generally to generate a digital video stream, or -signal, in which pixel values from the various projection images are, in effect, interwoven over several video lines. The generated signal (HD video signal 6, in the present case), as well as any reformatted version thereof (such as display video signal 7), is also referred to as an interwoven video signal.

HD Video Signal 6 is applied to Display Device 8 preferably through HD Display Interface 19. The latter is required if the display device is not directly receptive to the digital HD Video Signal but requires some other video signal format instead; such a format could also be an analog signal format. Optional Display Interface 19 serves to effect an appropriate conversion in real time, using techniques well known in the art. Preferably Display Interface 19 is configured to selectably output video signal 7 in any of a plurality of formats. Such display converters are commercially available from a variety of sources.

Optionally, or in certain configurations of the invention, HD Video Signal 6, or the display video signal 7 (output by Display Interface 19, as in the configuration of FIG. 1 or 3) can be stored in a Video Storage device 30. Video Capture unit 31, commercially available from a variety of sources, serves to capture video signal 6 or 8 and to input it, preferably as files, to storage device 30. The stored data may be read out at any time, converted to a video signal, by means of a readily available device, and displayed on a display device similar to display device 8.

Control of the operation of the entire system is effected through Controller 13, which communicates with all parts of the RMVADC 10, as well as possibly with external components (such as Video Synchronizer 5). In particular it serves to synchronize the timing of all the components and of data transfers between them.

The entire RMVADC 10 may be implemented by techniques and components well known in the art. Hardware components may include, but are not limited to, digital signal processors (DSP), field-programmable gate arrays (FPGA) and application-specific integrated circuits (ASIC). The RMVADC may be packaged in any of a variety of forms, including but not limited to a stand-alone box and a card pluggable into a general-purpose computer, into a video display device or into any component of the equipment that generates the projection video signals.

We claim:

1. A Method for real-time generation of a display video signal, adapted to be fed to an autostereoscopic display device for displaying an autostereoscopic video image of a changing three-dimensional scene, the display device including a matrix of active light-emitting or light-modulating elements, arranged in rows, and the display video signal structured as a sequence of frames, each frame structured as a sequence of lines that correspond to consecutive rows of said elements, the method comprising:
(d) Simultaneously obtaining a plurality of projection video signals, each signal structured as a sequence of frames representing two-dimensional projection images of the scene in a respective different direction and each frame including a plurality of pixels, each pixel carried as one or more digital values;
(e) copying pixel values from said projection video signals, or from any processed version thereof, into a digital representation of one or more of said rows so that values from different projection video signals become mutually interwoven.
(f) reading out said copied values from said digital representation in a line-by-line sequence and formatting them into the display video signal.

2. The method of claim 1, wherein there is a one-to-one correspondence between frames in the display video signal and frames in any of the projection video signals and the time delay between any pair of corresponding frames is equal to at most the duration of one frame.

3. The method of claim 1, wherein there is no limitation on the duration of any projection video signal or of the display video signal.

4. The method of claim 1, wherein each of said projection video signals is obtained by sensing the scene in any modality, including, but not limited to, passive optical sensing, ultrasonic echoing, radio echoing, optical echoing and x-ray projections.

5. The method of claim 1, wherein said copying is according to any given mapping function.

6. The method of claim 5, wherein said copying includes selectively copying according to the mapping function.

7. The method of claim 5, wherein said digital representation is of a plurality of rows and said copying includes copying each of said pixel values into a respective location in said digital representation according to the mapping function.

8. The method of claim 1, additionally comprising:
(g) For each projection video signal, correcting any occurring deviation of any pixel from its normal position within its respective frame.

9. The method of claim 1, additionally comprising:
(h) For each projection video signal, scaling each frame so that its resultant total number of pixels matches that required in steps ‘b’ and ‘c’ in order to fill the display device matrix or any designated portion thereof

10. The method of claim 7, additionally comprising:
(i) For each projection video signal, adjusting the values of any pixel, in dependency on any of its neighboring pixels, so as to match said values to the locations into which they are intended to be copied in step ‘b’.

11. The method of claim 1, wherein in step ‘c’ said formatting is adaptable to any standard video format.

12. The method of claim 1, wherein the display device may be any commercially available autostereoscopic active-matrix display device.

13. The method of claim 1, wherein the display video signal is further adaptable to be stored in a video storage device.

14. Apparatus for real-time conversion of a plurality of projection video signals, representative of a changeable three-dimensional scene as projected in respective different directions, into a display video signal, adapted to be fed to an autostereoscopic display device for displaying an autostereoscopic image of the scene, each of the projection video signals being structured as a sequence of frames representing corresponding sequential two-dimensional projection images of the scene, the display device including a matrix of active light-emitting or light-modulating elements, arranged in rows, and the display video signal structured as a sequence of frames, each frame structured as a sequence of lines that correspond to consecutive rows of said elements, the apparatus comprising:
a plurality of Conditioning Processors, each receptive to a respective projection video signal and operative to output digital values of sequential pixels representative of corresponding projection images;
a Combiner, including a buffer storage that is adapted to store image values for one or more of said rows, the Combiner being operative to copy values obtained from said Conditioning Processors into said buffer storage so that values from different Conditioning Processors become mutually interwoven; and
a Video Formatter, operative to read out said copied values from said buffer storage in a line-by-line sequence and to format them into the display video signal.

15. The apparatus of claim 14, wherein there is a one-to-one correspondence between frames in the display video signal and frames in any of the projection video signals and the time delay between any pair of corresponding frames is equal to at most the duration of one frame.

16. The apparatus of claim 14, wherein there is no limitation on the duration of any projection video signal or of the display video signal.

17. The apparatus of claim 14, wherein each of said Conditioning Processors includes a Format Converter, operative to convert the respective projection video signal from any standard format into a corresponding sequence of pixel values.

18. The apparatus of claim 14, wherein said Combiner is further operative to copy said values into the buffer storage according to any given mapping function.

19. The apparatus of claim 18, wherein said Combiner further includes a plurality of mapping filters, each receptive to digital values output by a respective Conditioning Processor and operative to copy them selectively according to the mapping function.

20. The apparatus of claim 18, wherein said buffer storage is adapted to store image values for a plurality of said rows and said Combiner further includes a Mapper, operative to address each of said values to a respective location in said buffer storage according to the mapping function.

21. The apparatus of claim 14, wherein each of said Conditioning Processors includes an Aligner, operative to correct any deviation of any pixel from its normal position within its respective frame, occurring in the respective projection video signal.

22. The apparatus of claim 14, wherein each of said Conditioning Processors includes a Scaler, operative to scale each frame as obtained from the respective projection video signal so that its resultant total number of pixels matches that required by said Combiner and said Video Formatter in order to fill the display device matrix or any designated portion thereof.

23. The apparatus of claim 20, wherein each of said Conditioning Processors is further operative to adjust the values of any pixel, in dependency on any of its neighboring pixels, so as to match said values to the location to which they are addressed by said mapper.

24. The apparatus of claim 14, wherein said Video Formatter is adaptable to format said copied values into a display video signal of any standard format.

25. A System for continuous real-time autostereoscopic display of a changing three-dimensional scene, comprising:
means for sensing the scene from a plurality of directions and for outputting a plurality of corresponding projection video signals;
an active-matrix autostereoscopic display device; and
apparatus receptive to said projection video signals and operative to convert them into a display video signal, adapted to be fed to said display device for displaying an autostereoscopic image of the scene.

26. The system of claim 25, wherein said apparatus includes:
a plurality of Conditioning Processors, each receptive to a respective projection video signal and operative to output digital values of sequential pixels representative of corresponding projection images;
a Combiner, including a buffer storage that is adapted to store image values for one or more of said rows, the Combiner being operative to copy values obtained from said Conditioning Processors into said buffer storage so that values from different Conditioning Processors become mutually interwoven; and
a Video Formatter, operative to read out said copied values from said Pixel Buffer in a line-by-line sequence and to format them into the display video signal.

27. The system of claim 25, wherein said sensing may be in any modality, including, but not limited to, passive optical sensing, ultrasonic echoing, radio echoing, optical echoing and x-ray projections.

28. The system of claim 25, wherein said means of sensing is a plurality of video cameras, disposed to view the scene from respective directions.
